(19) United States
(12) Patent Application Publication
(10) Pub. No.: US 2025/0353042 A1
(43) Pub. Date: Nov. 20, 2025

(54) ATOMIZATION OF CLEANING LIQUID DISPENSE IN CLEANER MODULES

(71) Applicant: Applied Materials, Inc., Santa Clara, CA (US)

(72) Inventors: Brian J. BROWN, Palo Alto, CA (US); Ekaterina A. MIKHAYLICHENKO, San Jose, CA (US)

(21) Appl. No.: 18/666,883

(22) Filed: May 17, 2024

(51) Int. Cl. B08B 3/02; B08B 1/12; B08B 5/02

(52) U.S. Cl. CPC B08B 3/024; B08B 1/12; B08B 5/02

(57) ABSTRACT

Embodiments herein generally relate to cleaning systems used with CMP systems and methods related thereto having atomizer nozzles. In an embodiment, a substrate processing system includes a polishing module including a transfer station and one or more polishing stations, the one or more polishing stations including at least one first nozzle configured to atomize a first cleaning liquid, a cleaning module including a brush cleaner, and a controller coupled to the polishing module and the cleaning module. In another embodiment, a substrate processing system includes a polishing module, a cleaning module having a brush cleaner at least one nozzle disposed within the brush cleaner, and a controller coupled to the polishing module and the cleaning module. The controller is configured to spray a substrate using the at least one nozzle of the brush cleaner where the at least one nozzle is configured to atomize a cleaning fluid.

### BACKGROUND

### Field

Embodiments of the present invention generally relate to semiconductor manufacturing, and in particular, to chemical mechanical polishing (CMP) systems and methods used in a semiconductor device manufacturing processes.

### Description of the Related Art

An integrated circuit is typically formed on a substrate (e.g., a semiconductor wafer) by the sequential deposition of conductive, semiconductive, or insulative layers on the substrate, and by the subsequent processing of the layers. Chemical mechanical polishing (CMP) is used to planarize the substrate and requires that a polishing liquid, such as a slurry with abrasive particles, be supplied to the surface of a polishing pad and pressed onto the substrate. To remove the polishing liquid, the substrates can be subjected to a cleaning process that includes the use of cleaning liquid.

However, metal layers on the substrate, when exposed to the cleaning fluids, are prone to corrosion and galvanic coupling, both of which are enhanced by the presence of undesired dissolved oxygen in the cleaning liquids. This corrosion leads to high contact resistance or opens of contacts and lines deposited on the substrate.

Accordingly, there is a need for improved systems and methods for spray cleaning a substrate in a substrate processing system that reduces corrosion and galvanic coupling.

### SUMMARY

Embodiments herein generally relate to semiconductor chemical mechanical polishing (CMP) systems, and in particular, to cleaning systems used with CMP systems and methods related thereto having atomizer nozzles.

In an embodiment, a substrate processing system is provided. The substrate processing system includes a polishing module including a transfer station and one or more polishing stations, the one or more polishing stations including at least one first nozzle configured to atomize a first cleaning liquid, a cleaning module including a brush cleaner, and a controller coupled to the polishing module and the cleaning module.

In another embodiment, a substrate processing system is provided. The substrate processing system includes a polishing module, a cleaning module having a brush cleaner at least one nozzle disposed within the brush cleaner, and a controller coupled to the polishing module and the cleaning module. The controller is configured to place, using a transfer robot, a substrate in a brush cleaner after polishing in the polishing module, spray the substrate using the at least one nozzle of the brush cleaner wherein the at least one nozzle is configured to atomize a cleaning fluid, and clean the substrate using a pair of rollers disposed within the brush cleaner.

In yet another embodiment, a substrate processing system is provided. The substrate processing system includes a polishing system having a loading station, and a controller coupled to the polishing system. The controller is configured to place, using a carrier head, a substrate onto a load cup of the loading station after chemical mechanical polishing, spray the substrate with a processing fluid using an atomizing nozzle assembly of the loading station while the substrate is disposed in the load cup, and remove, using the carrier head, the substrate from the load cup.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and the present disclosure may admit to other equally effective embodiments.

FIG. 1 is a schematic top view of a chemical mechanical polishing (CMP) system, according to certain embodiments.

FIG. 2 is an isometric view of one or more embodiments of a brush cleaner, according to certain embodiments.

FIG. 3 is a schematic, cross-sectional side view of a nozzle, according to certain embodiments.

FIG. 4 is a schematic, cross-sectional side view of a nozzle, according to certain embodiments.

FIG. 5 illustrates a block diagram of a method to clean a substrate while disposed in a brush cleaner, according to certain embodiments.

FIG. 6 is a schematic side view of an exemplary polishing system, according to certain embodiments.

FIG. 7 is a schematic sectional view of a loading station of the polishing system of FIG. 6, according to certain embodiments.

FIG. 8 illustrates a block diagram of a method to clean a substrate while the substrate is disposed in a loading station, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments herein generally relate to semiconductor chemical mechanical polishing (CMP) systems, and in particular, to cleaning systems used with CMP systems and methods related thereto having atomizer nozzles.

After chemical mechanical polishing (CMP), metal layers on the substrate, when subsequently exposed to cleaning liquids, are prone to corrosion and galvanic coupling, both of which are enhanced by the presence of undesired dissolved oxygen in the cleaning liquids. Corrosion leads to high contact resistance in contacts and lines deposited on the substrate. Most CMP cleaners have very high flow of exhaust fed by filtered fan units of air, which has oxygen which diffuses into the cleaning liquids during cleaning. Preventing oxygen diffusion into the liquids will suppress corrosion. Many CMP system modules, such as transfer modules, input modules, horizontal pre-clean modules, and brush boxes deliver a flow of deionized water or liquid chemical with a spray in an air environment. The deionized water may be degassed prior to being flowed into a cleaning module to remove dissolved oxygen, but the oxygen in the environment of the cleaning module can diffuse into the liquid, especially in small droplets with large surface area to volume ratios. Additionally, cleaning chemicals aside from deionized water may not be degassed and may contain sufficient amount of dissolved oxygen to cause corrosion.

The present disclosure provides for CMP modules that include gas/liquid atomizer nozzles. The gas/liquid atomizers may replace spray nozzles currently used in CMP transfer modules, input modules, brush boxes, pre-clean modules, or other CMP modules throughout the system. The gas flow and the liquid flow is adjusted to match desired recipes for substrate coverage and droplet momentum, e.g., droplet velocity and volume. This allows for the liquid flow to essentially be degassed as it enters the module. The gas flow also provides a simultaneous purge of the oxygen present in the module environment, reducing the presence of dissolved oxygen. Additionally, the liquid flow may be turned off during transfer such that only the gas flow continues, allowing for continuous gas purging of the modules and substrate to prevent oxidation.

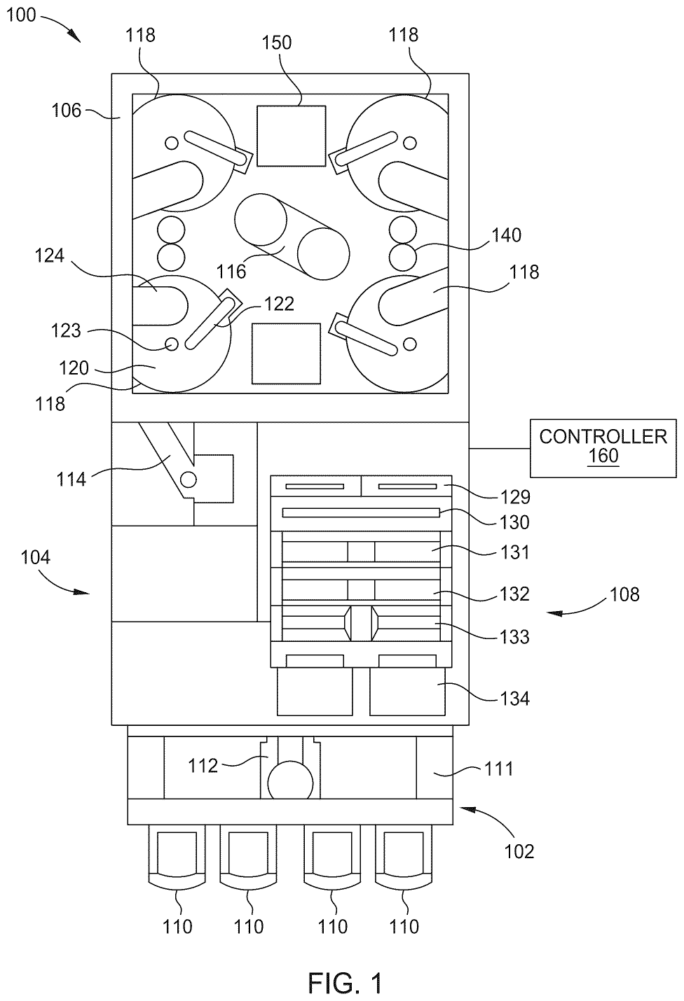

FIG. 1 illustrates a schematic top view of a chemical mechanical polishing (CMP) system 100. The CMP system 100 generally includes a factory interface module 102, an input module 104, a polishing module 106, and a cleaning module 108. These four major components are generally disposed within the CMP system 100.

The factory interface module 102 includes a support to hold a plurality of cassettes 110, a housing 111 that encloses a chamber, and one or more interface robots 112. The interface robot 112 generally provides the range of motion required to transfer substrates between the cassettes 110 and one or more of the other modules of the CMP system 100.

Unprocessed substrates are generally transferred from the cassettes 110 to the input module 104 by the interface robot 112. The input module 104 generally facilitates transfer of a substrate between the interface robot 112 and a transfer robot 114. The transfer robot 114 transfers the substrate between the input module 104 and the polishing module 106.

The polishing module 106 generally comprises a transfer station 116, one or more polishing stations 118, and one or more non-contact cleaning units 140. The transfer station 116 is disposed within the polishing module 106 and is configured to accept the substrate from the transfer robot 114. The transfer station 116 transfers the substrate to at least one carrier head 124 of a polishing station 118 that retains the substrate during polishing.

The polishing stations 118 each includes a rotatable disk-shaped platen on which a polishing pad 120 is situated. The platen is operable to rotate about an axis. The polishing pad 120 can be a two-layer polishing pad with an outer polishing layer and a softer backing layer. The polishing stations 118 each further includes a dispensing arm 122, to dispense a polishing liquid, e.g., an abrasive slurry, onto the polishing pad 120. In the abrasive slurry, the abrasive particles can be silicon oxide, but some polishing processes use cerium oxide abrasive particles. Each polishing station 118 can also include a conditioner head 123 to maintain the polishing pad 120 at a consistent surface roughness.

The polishing stations 118 each includes at least one carrier head 124. The at least one carrier head 124 is operable to hold a substrate against the polishing pad 120 during a polishing operation. Following the polishing operation performed on a substrate, the at least one carrier head 124 transfers the substrate back to the transfer station 116.

The transfer robot 114 then removes the substrate from the polishing module 106 through an opening connecting the polishing module 106 with the remainder of the CMP system 100. The transfer robot 114 removes the substrate in a horizontal orientation from the polishing module 106 and transfers the substrate to the cleaning module 108.

The non-contact cleaning unit 140 may employ methods like megasonic cleaning or spray cleaning to eliminate particles and contaminants from the substrate surface. For example, the non-contact cleaning unit 140 may include megasonic cleaning, which utilizes high-frequency sound waves to create cavitation bubbles in the cleaning solution. The implosion of these bubbles generates shock waves that dislodge particles and contaminants from the substrate surface. Alternatively, the non-contact cleaning unit 140 may include spray cleaning, where high-pressure jets of cleaning solution are used to dislodge particles and contaminants. The non-contact cleaning unit 140 may be a single-arm spray cleaning module, employing a single spray arm moving back and forth across the substrate or a dual-arm spray cleaning module with two spray arms moving in opposite directions. Further, the non-contact cleaning unit 140 may be a rotating spray cleaning module that features a rotating spray head above the substrate, spraying cleaning solution from all angles. Additionally, the non-contact cleaning unit 140 may be an inline spray cleaning module integrated into the CMP process line, transporting the substrate on a conveyor belt and spraying it from multiple angles. Conversely, an off-line spray cleaning module operates independently, cleaning substrates outside the CMP process line, which may be loaded manually or with the transfer robot 114.

The cleaning module 108 generally includes one or more cleaning devices that can operate independently or in concert. For example, the cleaning module 108 can include an input module 129, one or more brush or buffing pad cleaners 131, 132, a megasonic cleaner 133, and a drying module 134. Other possible cleaning devices include chemical spin cleaners and jet spray cleaners (not shown). A transport system, e.g., an overhead conveyor 130 that supports robot arms, can walk or run the substrate from cleaning device to cleaning device. Additionally, overhead transfer robots can be used for this same transport of substrates. Briefly, the one or more brush or buffing pad cleaners 131, 132 are devices in which the substrate can be placed and the surfaces of the substrate are contacted with rotating brushes or spinning buffing pads to remove any remaining particulates. The substrate may then be transferred to the megasonic cleaner 133 in which high frequency vibrations produce controlled cavitation in a cleaning liquid to clean the substrate. Alternatively, the megasonic cleaner 133 can be positioned before the brush or buffing pad cleaners 131, 132. A final rinse can be performed in a rinsing module before being transferred to the drying module 134.

The CMP system 100 includes a controller 160, which generally includes one or more processors, memory, and support circuits. The one or more processors may include a central processing unit (CPU) and may be one of any form of a general purpose processor that can be used in an industrial setting. The memory, or non-transitory computer-readable medium, is accessible by the one or more processors and may be one or more of memory such as random access memory (RAM), read only memory (ROM), floppy disk, hard disk, or any other form of digital storage, local or remote. The support circuits are coupled to the one or more processors and may comprise cache, clock circuits, input/output subsystems, power supplies, and the like. The various methods disclosed herein may generally be implemented under the control of the one or more processors by the one or more processors executing computer instruction code stored in the memory as, for example, a software routine. When the computer instruction code is executed by the one or more processors, the one or more processors controls the CMP system 100 to perform processes in accordance with the various methods disclosed herein.

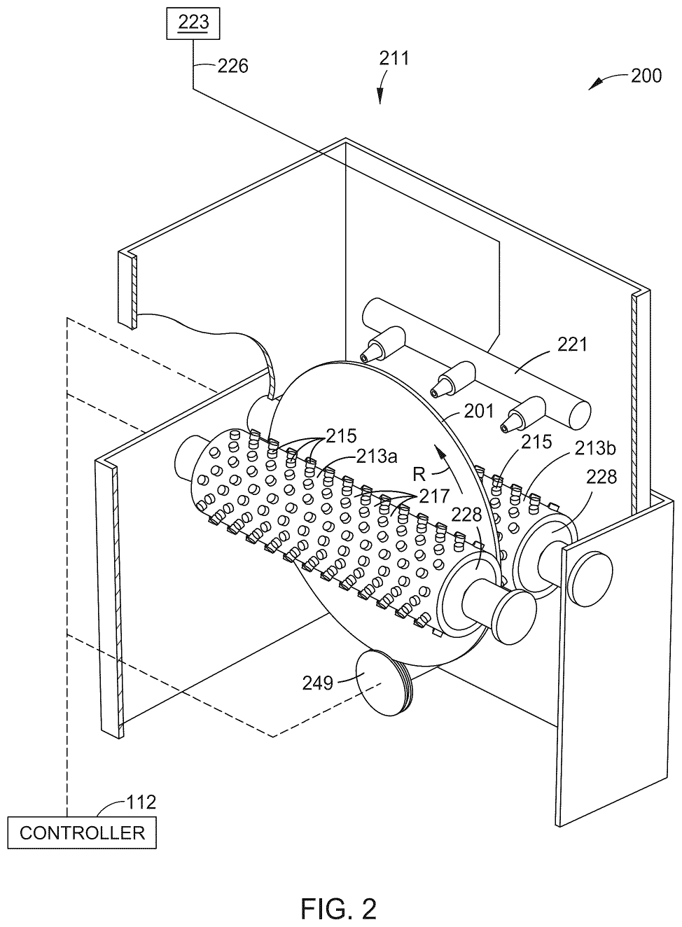

FIG. 2 is an isometric view of one or more embodiments of a scrubbing device 211 disposed within the brush cleaner 200. The scrubbing device 211 shown in FIG. 2 is depicted with a substrate 201 loaded therein, such that the scrubbing device 211 is in a loaded state. The scrubbing device 211 comprises a pair of cylindrical rollers 228. Each brush includes a set of multiple raised nodules 215 across the surface of the brush, and a set of multiple valleys 217 located among the nodules 215. The pair of cylindrical rollers 228 are supported by a pivotal mounting into and out of contact with the substrate 201 supported by a substrate support (which may also be referred to as a substrate support), thus allowing the cylindrical rollers 228 to move between closed and open positions so as to allow a substrate 201 to be extracted from and inserted therebetween as described below. In alternative embodiments, the substrate 201 may be positioned horizontally in a horizontally-oriented embodiment of the brush cleaner 200, where the brush cleaner 200 includes a cylindrical roller 228 positioned below and another cylindrical roller 228 positioned above the substrate 201.

The scrubbing device 211 also comprises a substrate support adapted to support and further adapted to rotate a substrate 201. In one aspect, the substrate support may comprise a plurality of rollers, e.g., roller 249, having a groove adapted to support the substrate 201 vertically. The roller 249 may be coupled to an actuator (not shown) and adapted to rotate.

The scrubbing device 211 may further comprise a plurality of sprayers 221 coupled to a source 223 of cleaning fluid via a supply pipe 226. The sprayers 221 are configured to dispense a high-pressure liquid spray or low-pressure liquid spray onto the substrate surfaces, aiding in the removal of particles, contaminants, and residues. The sprayers 221 can incorporate various configurations, such as a fluid jet, spray bar with nozzles, shower-style spray manifold, or cryogenic aerosol jet.

In various embodiments of the present disclosure, the cleaning fluid utilized in the brush cleaner may include, but is not limited to deionized (DI) water, diluted citric acid, diluted quaternary ammonium compound (a mixture of organic solvents, such as glycol ether, tetramethyl ammonium hydroxide, and other additives), diluted ammonium hydroxide (NH₄OH), diluted hydrogen peroxide (H₂O₂), an NH₄OH and H₂O₂ mixture, diluted hydrofluoric acid, sulfuric acid (H₂SO₄) and hydrogen peroxide (H₂O₂) mixture (SPM), or any other liquid solution used for substrate cleaning.

In one or more embodiments, the sprayers 221 may be positioned to spray a cleaning fluid at the surfaces of the substrate 201 or at the one or more scrubber brushes during a scrubbing process. In one or more embodiments, substrate cleaning fluid and/or brush cleaning fluid may be supplied from an internal region of the scrubber brushes, e.g., cylindrical rollers 228, themselves. Fluids provided to the interior of the scrubber brushes passes through pores in the tubular covers (not shown) to clean the surface of the substrate or remove debris found on the surface of the scrubber brushes.

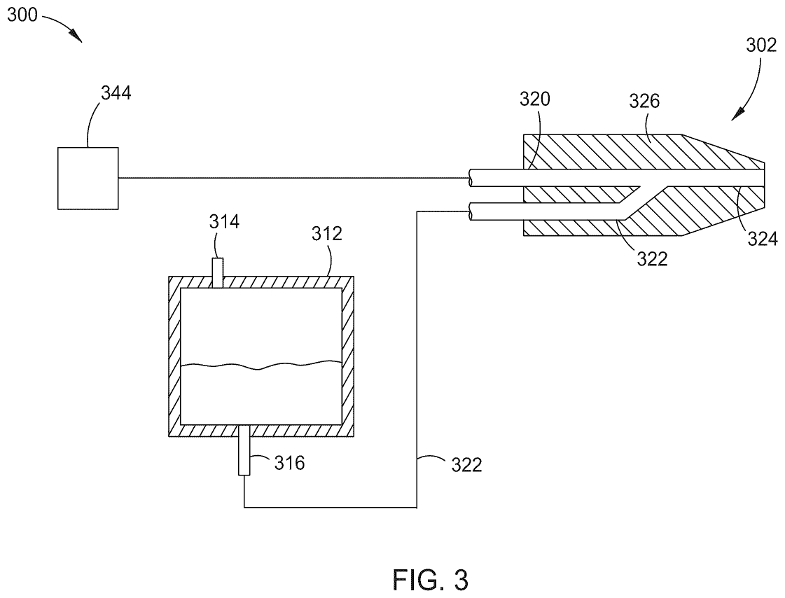

FIG. 3 illustrates a schematic, cross-sectional view of an atomizing nozzle assembly 300 for use in modules of the CMP system 100. In one embodiment, the sprayers 221 of FIG. 2 include nozzles 302 that are ultrasonic spray nozzles, or “air atomizing nozzles.” FIG. 3 shows a cross-sectional view of an air atomizing nozzle 302 in one design. This is an internal fluid mix type nozzle. This means that fluids are mixed internally to produce a completely atomized spray, or mist of the processing fluid. In this configuration a carrier gas, e.g., nitrogen, contains small droplets of processing solution. In one embodiment, an inert gas may be used to transport an atomized activation solution to the substrate surface. Alternatively, the mixture of gas and liquid does not produce the fully atomized spray but may produce a partially atomized spray. In such examples, the gas flow partially mixes with the liquid flow to replace the oxygen dissolved in the processing fluid with the inert gas, which prevents environmental oxygen diffusion into the processing fluid.

In the atomizing nozzle assembly 300, the nozzle 302 includes a body 326 and a tip 324. The tip 324 is generally about 10 μm to about 200 μm in diameter, such as about 10 μm to about 50 μm in diameter. Fluids are delivered through the tip 324 due to suction created by a Venturi effect created when high pressure gas is delivered from a nozzle gas supply 344 to a gas channel 320 in the body 326. As shown in FIG. 3, the body 326 provides separate channels, e.g., the gas channel 320 and a liquid channel 322, for receiving separate gas and liquid streams, respectively. The gas channel 320 and liquid channel 322 merge at the tip 324, allowing the two streams to blend. In this arrangement, fluid distributed from the nozzle 302 is pre-mixed to produce a completely atomized spray. The particular design of tip 324 produces a round spray pattern. However, it is understood that other tip configurations may be used to produce other spray patterns, such a flat or fan spray pattern.

A liquid supply is provided for liquids delivered to the nozzles 302. A liquid tank 312 is coupled to the nozzle 302 by the liquid channel 322 and includes a vent 314. The vent 314 may be in fluid communication with atmospheric pressure. In addition, a liquid outlet 316 is disposed through an opening in the liquid tank 312 and coupled to the liquid channel 322 allowing the cleaning liquid within the liquid tank 312 to exit the tank and enter the liquid channel 322. During gas delivery, gases from the nozzle gas supply 344 are delivered to the nozzle 302 at high velocities. The high velocity of the gas flow through the gas channel 320 creates a relative negative pressure in liquid channel 322 caused by the fluid communication with atmospheric pressure in the liquid tank 312 through vent 314. The liquid from the liquid tanks is then urged through the outlet 316 and into the nozzle 302 via the liquid channel 322.

The cleaning liquid may be degassed prior to being supplied to the nozzles 302. For example, the cleaning liquid may be degassed using a vacuum. In such examples, the cleaning liquid is exposed to vacuum pressure in a vacuum degasser (not shown) to reduce the solubility of oxygen which, in turn, extracts oxygen from the cleaning liquid. Alternatively, the cleaning liquid may be degassed in a degassing chamber (not shown) using an inert gas, such as nitrogen or argon. For example, the inert gas may be flowed or bubbled through the cleaning liquid to displace dissolved oxygen within the cleaning liquid. The bubbles of inert gas provide a surface area for the dissolved oxygen to adhere to and, as the bubbles rise out of the cleaning liquid, the bubbles carry the oxygen out of the cleaning liquid.

In one embodiment, the cleaning liquid supplied to the nozzle 302 by the liquid tank 312 is deionized (DI) water. Alternatively, the cleaning liquid may be a cleaning solution. The gas supply 344 may supply an oxygen-free inert gas, such as nitrogen (N₂) or argon (Ar), to the nozzle 302.

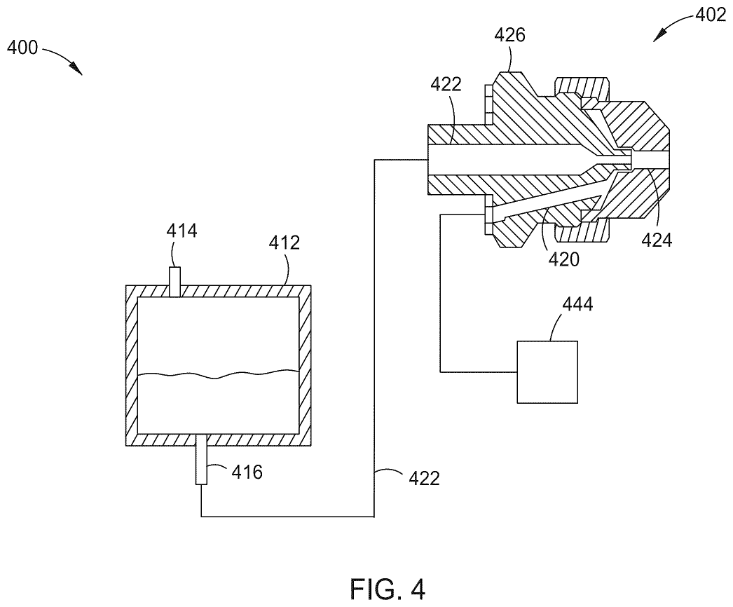

FIG. 4 provides a cross-sectional view of an atomizing nozzle assembly 400 in an external fluid mix nozzle. As shown in FIG. 4, a nozzle 402 includes a body 426 and a tip 424. The tip 424 is generally about 10 μm to about 200 μm in diameter or, in another embodiment, about 10 μm to about 50 μm in diameter. In the arrangement of FIG. 4, the body 426 provides separate channels, e.g., a gas channel 420 and a fluid channel 422 for receiving separate gas and liquid streams, respectively. In this configuration, the liquid channel 422 delivers liquid through the nozzle 402 independently of the gas channel 420 so that the two streams do not blend within the body 426, but mix outside of the tip 424 of the nozzle 402. This arrangement has the benefit that gas and liquid flow can be controlled independently, which is effective for higher viscosity liquids and abrasive suspensions.

A liquid supply is provided for liquids delivered to the nozzles 402. A liquid tank 412 is coupled to the nozzle 402 by the liquid channel 422 and includes a vent 414. The vent 414 may be in fluid communication with atmospheric pressure. In addition, a liquid outlet 416 is disposed through an opening in the liquid tank 412 and coupled to the liquid channel 422 allowing the cleaning liquid within the liquid tank 412 to exit the tank and enter the liquid channel 422. During gas delivery, gases from the nozzle gas supply 444 are delivered to the nozzle 402 at high velocities. The high velocity of the gas flow through the gas channel 420 creates a relative negative pressure in liquid channel 422 caused by the fluid communication with atmospheric pressure in the liquid tank 412 through vent 414. The liquid from the liquid tanks is then urged through the outlet 416 and into the nozzle 402 via the liquid channel 422.

The cleaning liquid may be degassed to produce a degassed cleaning liquid prior to being supplied to the nozzle 402. For example, the cleaning liquid may be degassed using a vacuum. In such examples, the cleaning liquid is exposed to vacuum pressure in a vacuum degasser (not shown) to reduce the solubility of oxygen which, in turn, extracts oxygen from the cleaning liquid. Alternatively, the cleaning liquid may be degassed in a degassing chamber (not shown) using an inert gas, such as nitrogen or argon. For example, the inert gas may be flowed or bubbled through the cleaning liquid to displace dissolved oxygen within the cleaning liquid. The bubbles of inert gas provide a surface area for the dissolved oxygen to adhere to and, as the bubbles rise out of the cleaning liquid, the bubbles carry the oxygen out of the cleaning liquid to produce the degassed cleaning liquid.

In one embodiment, the cleaning liquid supplied to the nozzle 402 by the liquid tank 412 is deionized (DI) water. Alternatively, the cleaning liquid may be a cleaning solution that is degassed, e.g., having dissolved oxygen removed. The gas supply 444 may supply an oxygen-free inert gas, such as nitrogen (N₂) or argon (Ar), to the nozzle 402.

The use of the atomizing nozzle assembly 300 of FIG. 3 or the atomizing nozzle assembly 400 of FIG. 4 produces an atomized mist directed at the receiving surface of a substrate within the cleaning modules of the CMP system 100. The atomized mist would include the cleaning liquid and the oxygen-free inert gas. The use of the inert gas to atomize the cleaning liquid aids in minimizing the interaction of the cleaning liquid, e.g., deionized water or other cleaning solution, with oxygen in the air environment of a cleaning module. The inert gas then prevents the development and accumulation of dissolved oxygen within the droplets of the cleaning liquid from the tip of the nozzle, e.g., tip 324 or tip 424, to the receiving surface of the substrate. If the gas supply, e.g., the nozzle gas supply 344, is flowed after the cleaning liquid supply 312 is shut off, the inert gas provides a purge of the ambient air, and more importantly, the environmental oxygen within the cleaning module. This gas purge prevents the accumulation of dissolved oxygen on the surface of the substrate after a cleaning process, which reduces overall contamination and corrosion of the structures previously formed on the substrate surface.

Alternatively, the atomizing nozzle assembly, e.g., the atomizing nozzle assembly 300 or the atomizing nozzle assembly 400, does not produce a fully atomized spray but rather a partially atomized spray. The processing fluid flow is partially mixed with the inert gas of the inert gas flow, which provides a barrier that prevents oxygen infusion into the processing fluid, e.g., prevents dissolved oxygen from accumulating in the processing fluid, during dispense in the brush box cleaning module.

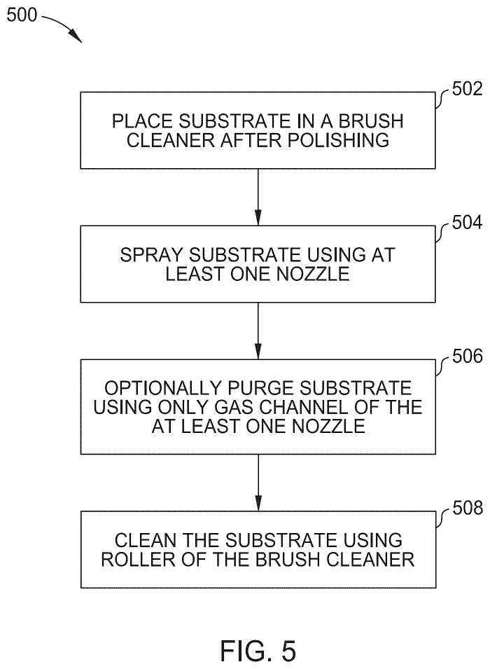

FIG. 5 shows a block diagram of a method 500 to clean a substrate while it is disposed in a brush cleaner, e.g., brush cleaner 200 of FIG. 2, using an atomizing nozzle assembly, e.g., the atomizing nozzle assembly 300 of FIG. 3 or the atomizing nozzle assembly 400 of FIG. 4. The controller(s) discussed above, e.g., controller 160, may be configured to execute the method 500. The method begins with operation 502 where the substrate is placed into the brush cleaner.

In operation 504, the substrate is sprayed with a cleaning fluid using one or more nozzles 302, 402 of the brush cleaner. The cleaning liquid may be, for example, an acid- or base-containing aqueous solution or deionized (DI) water. The cleaning liquid may be supplied to the substrate via a liquid channel, e.g., the liquid channel 322, 422. The one or more nozzles may also supply a gas via a gas channel, e.g., gas channel 320, 420. The gas may be an inert gas, such as nitrogen (N₂) or argon (Ar). The gas may be flowed at a flow rate such that, when flowed with the cleaning liquid, would atomize the cleaning fluid as it contacts the substrate. Atomizing the cleaning liquid with the inert gas prevents dissolved oxygen from forming within the droplets of the cleaning fluid, e.g., degassing the cleaning fluid, by preventing ambient oxygen from reacting with the cleaning fluid. This reduction in dissolved oxygen prevents oxidation of particles on the surface of the substrate, ensuring a cleaner substrate surface.

Optionally, in operation 506, the substrate may be purged while disposed in the brush cleaner. The controller may be configured to purge the substrate in the brush cleaner by flowing the gas through the gas channel 320, 420 of the one or more nozzles 302, 402 of the brush cleaner. The gas channel 420 may flow the same gas as it flowed in operation 504 to atomize the cleaning fluid at the same or different flow rate. Alternatively, the gas channel may flow a different inert gas. The operation 506 may follow immediately after operation 504. Alternatively, the operation 506 may occur before operation 504. In alternative methods with repeating operation 504, the operation 506 may occur between each successive operation 504. Flowing the gas during operation 506, prevents ambient oxygen from contacting particles on the surface of the substrate, reducing oxidation and preventing dissolved oxygen from forming in process fluids including cleaning fluids. In operation 508, the substrate is scrubbed in the brush cleaner using the pair of rollers 228.

The method 500 of FIG. 5 allows for a substrate to be effectively cleaned by the brush cleaner 200 following a CMP process while minimizing particle contamination and corrosion of the structures formed on the surface of the substrate.

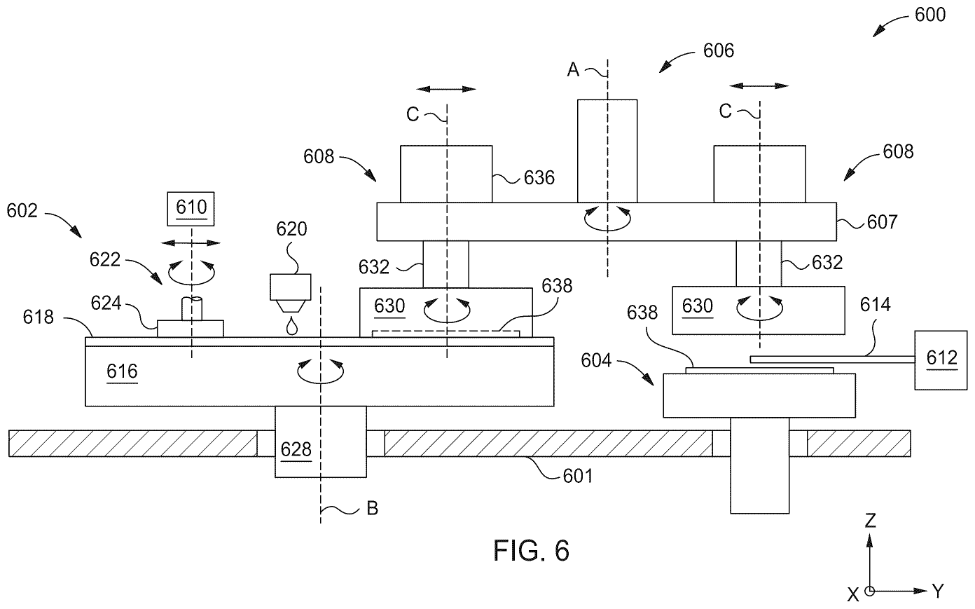

FIG. 6 is a schematic side view of an exemplary polishing system 600 which may be used to perform the methods set forth herein. Here, the polishing system 600 includes a base 601, a plurality of polishing stations 602 (one shown), a loading station 604, a carrier transport system 606, a plurality of carrier assemblies 608, and a system controller 610.

The loading station 604 is used to receive substrates from a substrate handler 612, e.g., a robot having an end effector 614, and return substrates back thereto and to load and unload substrates to and from individual ones of the carrier assemblies 608. The carrier transport system 606 may comprise any suitable system for supporting the plurality of carrier assemblies 608 and for moving the carrier assemblies 608 between the loading station 604 and one or more of the plurality of polishing stations 602 for substrate processing thereon. As shown in FIG. 6, the carrier transport system 606 is a pivot module which moves the plurality of carrier assemblies 608 between the polishing station 602 and the loading station 604 by pivoting a support arm 607 about an axis A.

The polishing station 602 includes a platen 616 having a polishing pad 618 mounted thereon, a fluid delivery arm 620, and a pad conditioner assembly 622. The platen 616 is rotatable about an axis B using an actuator 628 coupled thereto. The fluid delivery arm 620 is positioned over the platen 616 and is used to deliver a polishing fluid, such as a polishing slurry having abrasives suspended therein, to a surface of the polishing pad 618. Typically, the polishing fluid contains a pH adjuster and other chemically active components, such as an oxidizing agent, to enable chemical mechanical polishing of the material surface of the substrate. The pad conditioner assembly 622 is used urge a fixed abrasive conditioning disk 624 against the polishing pad 618 before, after, or during polishing of a substrate in order to abrade, rejuvenate, and remove polish byproducts from, the surface of the polishing pad 618.

The carrier assemblies 608 are used to transport substrates to and from individual ones of the plurality of polishing stations 602 and therebetween and to urge the substrates against the rotating polishing pads in the presence of the polishing fluid. Here, each of the carrier assemblies 608 includes a carrier head 630, a carrier shaft 632 coupled to the carrier head 630, and one or more actuators 636 coupled to the carrier shaft 632. The one or more actuators 636 are used to rotate the carrier head 630 about a carrier axis C, and to sweep the carrier head 630 between an inner radius and an outer radius of the polishing pad 618 while the carrier head 630 simultaneously exerts a force against a backside or non-active surface of a substrate 638 disposed therein.

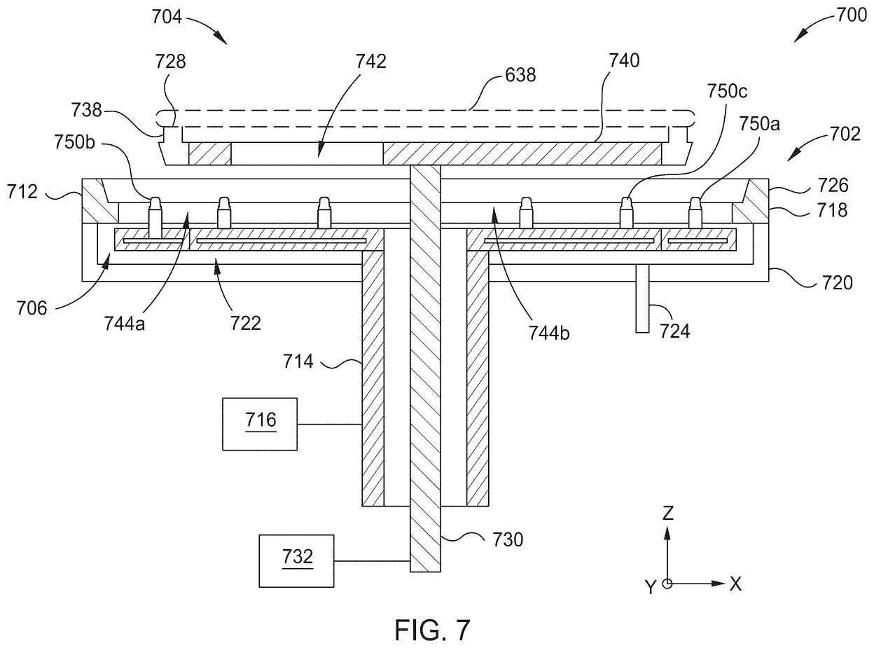

FIG. 7 is a schematic sectional view of a loading station 700, e.g., the loading station 604. The loading station 700 includes a cup assembly 702, a pedestal assembly 704 concentrically disposed within in the cup assembly 702, and a fluid delivery assembly 706. The cup assembly 702 includes a load cup 712 disposed on a first shaft 714 and an actuator 716 coupled to the first shaft 714 which is used to move the load cup 712 in the Z-direction, i.e., towards and away from a carrier head positioned thereover (not shown). The load cup 712 includes an annular upper portion 718 and a lower housing 720 which collectively define a basin 722 for collecting fluids used during the carrier and substrate cleaning methods set forth herein. Fluids are drained from the basin 722 using a drain 724 fluidly coupled thereto.

The upper portion 718 includes one or more carrier alignment features, here an annular lip 726, extending upwardly from an upward facing surface of the upper portion 718 and located proximate to the peripheral edge thereof. During transfer of a substrate 638 (shown in phantom in FIG. 7) to and from a carrier head (not shown), the load cup 712 is moved in the Z-direction to a raised position (not shown) so that the annular lip 726 surrounds a portion of the outwardly facing surface of the carrier head to facilitate alignment between the carrier head and the load cup 712.

The pedestal assembly 704 includes a pedestal 728 disposed on a second shaft 730 and an actuator 732 coupled to the second shaft 730 which is used to move the pedestal in the Z-direction. The pedestal 728 has a generally circular shape when viewed from top down and an annular lip 738 disposed proximate to the circumferential edge of the pedestal 728 and extending upwardly therefrom. The annular lip 738 is sized and positioned to engage with the radially outermost portions of the active surface of the substrate 638, thus supporting the substrate 638 away from a recessed surface 740 of the pedestal 728 in order to minimize contact with, and to avoid the related scratching of, devices manufactured thereon.

The pedestal 728 is movable in the Z-direction relative to the load cup 712 and may be extended upwardly therefrom and retracted thereinto to provide access to an end effector 614 (FIG. 6) of a substrate handler 612 and to facilitate substrate loading and unloading from the carrier head positioned thereabove. Here, the pedestal 728 has an opening 742 disposed therethrough and a plurality of cutouts 744a disposed about a peripheral edge thereof. The upper portion 718 of the load cup 712 features a corresponding plurality of cutouts 744b formed in the radially inward facing surface thereof which are aligned with the plurality of cutouts 744a formed in the edge of the pedestal. The opening 742 and cutouts 744a,b enable the fluid delivery assembly 706 disposed therebeneath to direct fluids towards desired surfaces of a carrier head (or a vacuum chucked substrate) positioned over the loading station 700 and aligned therewith.

The fluid delivery assembly 706 is fixedly coupled to the load cup 712 and includes a one or more first nozzles 750a, one or more second nozzles 750b, and a plurality of third nozzles 750c. The one or more first nozzles 750a and the one or more second nozzles 750b are aligned with the openings formed by the cutouts 744a, b when viewed form top down. In some embodiments, the one or more first nozzles 750a and one or more second nozzles 750b are used to direct cleaning fluids towards an annular gap disposed between a flexible membrane and the retaining ring of a rotating carrier head to remove polishing byproducts therefrom.

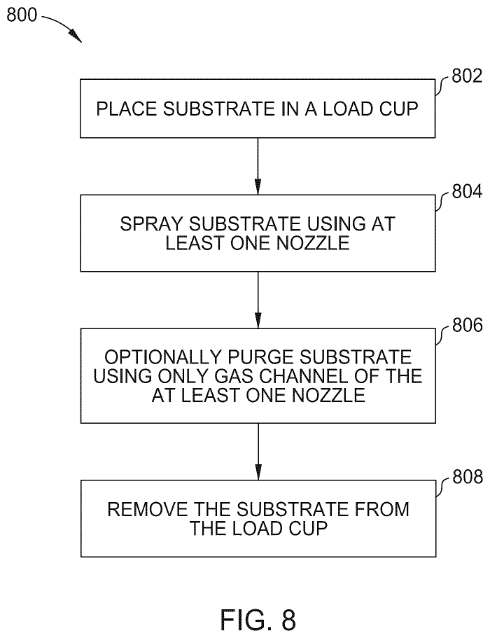

FIG. 8 shows a block diagram of a method 800 to clean a substrate, e.g., the substrate 638, using an atomizing nozzle assembly, e.g., the atomizing nozzle assembly 300 of FIG. 3 or the atomizing nozzle assembly 400 of FIG. 4, while the substrate is disposed in a load cup, e.g., load cup 712 of FIG. 7. The controller(s) discussed above, e.g., controller 610, may be configured to execute the method 800. The method 800 begins with operation 802 where the substrate 638 is placed into the load cup 712.

In operation 804, the substrate 638 is sprayed with a cleaning liquid using a plurality of nozzles, e.g., the first plurality of nozzles 750a (e.g., 302, 402), of the load cup 712. The cleaning liquid may be, for example, an acid- or base-containing aqueous solution or deionized (DI) water. The cleaning liquid may be supplied to the substrate 638 via a liquid channel, e.g., the liquid channel 322, 422. The first plurality of nozzles 750a (302, 402) may also supply a gas via a gas channel, e.g., gas channel 320, 420. The gas may be an inert gas, such as nitrogen (N₂) or argon (Ar). The gas may be flowed at a flow rate such that, when flowed with the cleaning liquid, would atomize the cleaning liquid as it contacts the substrate 638. Atomizing the cleaning liquid with the inert gas prevents dissolved oxygen from forming within the droplets of the cleaning liquid, e.g., degassing the cleaning liquid, by preventing ambient oxygen from reacting with the cleaning liquid. This reduction in dissolved oxygen prevents oxidation of particles on the surface of the substrate, providing a cleaner substrate surface.

Optionally, in operation 806, the substrate 638 may be purged by the inert gas from the gas supply 344, 444 via the first plurality of nozzles 750a (302, 402) while the substrate 638 is disposed in the load cup. The controller 610 may be configured to purge the substrate in the load cup by flowing the gas through the gas channel 320, 420 of the one or more nozzles of the load cup. The gas channel 320, 420 may flow the same gas as it flowed in operation 804 to atomize the cleaning fluid at the same or different flow rate. Alternatively, the gas channel 320, 420 may flow a different inert gas for purging. The operation 806 may follow immediately after operation 804. Alternatively, the operation 806 may occur before operation 804. Additionally, the operation 806 may occur both before and after the operation 804. For example, the substrate is purged by the gas supply 344, 444 while it is placed into the load cup 712, then it is cleaned by the atomized mist of cleaning liquid and inert gas, then the substrate 638 is purged while it transitions out of the load cup 712. In alternative methods with repeating operation 804, the operation 806 may occur between each successive operation 804. Flowing the inert gas during operation 806 to create a gas purge prevents environmental oxygen within the cleaning module from contacting particles on the surface of the substrate, reducing oxidation and preventing dissolved oxygen from forming in process fluids including cleaning fluids. In operation 808, the substrate is removed from the loading cup for further processing.

The method 800 of FIG. 8 allows for a substrate to be effectively cleaned by the load cup 712 following a CMP process while minimizing particle contamination and corrosion of the structures formed on the surface of the substrate.

The present disclosure provides for a CMP system where liquid nozzles that form sprays are replaced by gas/liquid atomizer nozzles or gas/liquid mixing nozzles with partial atomization in various CMP modules. The gas and liquid flows are adjusted to match desired recipes for substrate coverage and droplet momentum, e.g., droplet velocity and volume. Additionally, the liquid flow may be turned off during transfer such that only the gas flow continues, allowing for additional purging of the modules and substrate to prevent oxidation. The embodiments of the present disclosure allow for ease of implementation in existing systems, e.g., do not significantly change system hardware, and do not require hermetic sealing of the cleaner or running significant amounts of gas. The atomized droplets can be tuned with nozzle design and flows, depending on the application within the CMP system, to improve substrate coverage and contribute to particle removal from the substrate. Additionally, the present disclosure effectively degasses the incoming chemicals to prevent dissolved oxygen from interacting with the substrate surface.

When introducing elements of the present disclosure or exemplary aspects or embodiments thereof, the articles “a,” “an,” “the” and “said” are intended to mean that there are one or more of the elements.

The terms “comprising,” “including” and “having” are intended to be inclusive and mean that there may be additional elements other than the listed elements.

The term “coupled” is used herein to refer to the direct or indirect coupling between two objects. For example, if object A physically touches object B and object B touches object C, the objects A and C may still be considered coupled to one another-even if objects A and C do not directly physically touch each other. For instance, a first object may be coupled to a second object even though the first object is never directly in physical contact with the second object.

While the foregoing is directed to embodiments of the present disclosure, other and further embodiments of the disclosure may be devised without departing from the basic scope thereof, and the scope thereof is determined by the claims that follow.

What is claimed is:

1. A substrate processing system, comprising:
a polishing module comprising a transfer station and one or more polishing stations, the one or more polishing stations comprising at least one first nozzle configured to atomize a first cleaning liquid;
a cleaning module comprising a brush cleaner; and
a controller coupled to the polishing module and the cleaning module.

2. The substrate processing system of claim 1, wherein the brush cleaner comprises at least one second nozzle configured to atomize a second cleaning fluid.

3. The substrate processing system of claim 1, wherein the at least one first nozzle of the one or more polishing stations comprises a gas channel configured to supply a gas to a substrate and a liquid channel configured to supply the first cleaning liquid to a substrate and wherein the gas channel and the liquid channel merge in a body of the at least one first nozzle.

4. The substrate processing system of claim 3, wherein the at least one first nozzle is configured to partially atomize the first cleaning fluid wherein the first cleaning fluid is mixed with the gas to prevent dissolved oxygen from accumulating.

5. The substrate processing system of claim 3, wherein the controller is configured to purge a substrate disposed in the one or more polishing stations using the gas channel of the at least one first nozzle of the one or more polishing stations.

6. The substrate processing system of claim 2, wherein the at least one second nozzle of the brush cleaner comprises a gas channel configured to supply a gas to a substrate and a liquid channel configured to supply the second cleaning liquid to a substrate and wherein the liquid channel and the gas channel are separate such that the liquid flow and the gas flow merge outside of a body of the at least one second nozzle.

7. The substrate processing system of claim 6, wherein the controller is configured to purge a substrate disposed in the brush cleaner using the gas channel of the at least one second nozzle of the brush cleaner.

8. The substrate processing system of claim 1, wherein the first cleaning fluid is a degassed cleaning fluid having dissolved oxygen removed prior to flow into the at least one first nozzle.

9. A substrate processing system, comprising:
a polishing module;
a cleaning module having a brush cleaner
at least one nozzle disposed within the brush cleaner; and
a controller coupled to the polishing module and the cleaning module and configured to:
place, using a transfer robot, a substrate in a brush cleaner after polishing in the polishing module;
spray the substrate using the at least one nozzle of the brush cleaner wherein the at least one nozzle is configured to atomize a cleaning fluid; and
clean the substrate using a pair of rollers disposed within the brush cleaner.

10. The substrate processing system of claim 9, wherein spraying the substrate comprises atomizing a cleaning fluid using a liquid flow from a liquid channel and a gas flow from a gas channel of the at least one nozzle.

11. The substrate processing system of claim 10, wherein the controller is further configured to:
after spraying, but before cleaning the substrate, purging the substrate using only the gas channel of the at least one nozzle to supply a gas to the substrate.

12. The substrate processing system of claim 11, wherein the gas is an inert gas.

13. The substrate processing system of claim 10, wherein the liquid channel and the gas channel merge at a tip of the at least one nozzle such that the liquid flow and the gas flow merge within a body of the at least one nozzle.

14. The substrate processing system of claim 10, wherein the liquid channel and the gas channel are separate such that the liquid flow and the gas flow merge outside of a body of the at least one nozzle.

15. A substrate processing system, comprising:
a polishing system having a loading station; and
a controller coupled to the polishing system and configured to:
place, using a carrier head, a substrate onto a load cup of the loading station after chemical mechanical polishing;
spray the substrate with a processing fluid using an atomizing nozzle assembly of the loading station while the substrate is disposed in the load cup; and
remove, using the carrier head, the substrate from the load cup.

16. The substrate processing system of claim 15, wherein spraying the substrate comprises atomizing the processing fluid using a liquid flow from a liquid channel of the atomizing nozzle assembly and a gas flow from a gas channel of the atomizing nozzle assembly.

17. The substrate processing system of claim 16, wherein the controller is further configured to:
after spraying, but before removing the substrate, purge the substrate using only the gas channel of the atomizing nozzle assembly to supply a gas to the substrate.

18. The substrate processing system of claim 15, wherein the processing fluid is a cleaning fluid.

19. The substrate processing system of claim 16, wherein the liquid channel and the gas channel merge at a tip of the atomizing nozzle assembly such that the liquid flow and the gas flow merge within a body of a nozzle of the atomizing nozzle assembly.

20. The substrate processing system of claim 16, wherein the liquid channel and the gas channel are separate such that the liquid flow and the gas flow merge outside of a body of a nozzle of the atomizing nozzle assembly.
